(19) United States
(12) Patent Application Publication
(10) Pub. No.: US 2006/0146719 A1
(43) Pub. Date: Jul. 6, 2006

(54) Web-based navigational system for the disabled community

(76) Inventors: Adam Douglas Sobek, Salt Lake City, UT (US); Harvey J. Miller, Salt Lake City, UT (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 11/268,886

(22) Filed: Nov. 8, 2005

Related U.S. Application Data
(60) Provisional application No. 60/626,068, filed on Nov. 8, 2004.

(51) Int. Cl. H04J 3/14

(52) U.S. Cl. 370/238

(57) ABSTRACT

The present invention relates to systems and methods for using a Web-based navigational tool, to assist people of varying physical ability levels in identifying shortest feasible routes through urban environments. One embodiment of the present invention is comprised of an application, which is constructed using Scalar Vector Graphics (created by Adobe(®) for data presentation and Java2® technology for route computation. The present invention allows users to select an origin, a destination, and an ability level. In one embodiment of the present invention a user may choose which of three options best matches their ability level: ambulatory, ambulatory with aid, or disabled. The present invention then returns a fast, accurate route and its distance. Since the present invention is served over the Web, it is very accessible to the university community and the general public as well. The present invention is designed to assist both local authorities and disabled groups by providing a fully interactive route-finding application that identifies shortest feasible routes.

### RELATED APPLICATIONS

This application claims priority to U.S. Provisional Patent Application No. 60/626,068, filed Nov. 8, 2004.

### BACKGROUND OF THE INVENTION

1. Field of the Invention

The present invention relates to systems and methods for using a navigational tool, to assist people of varying physical abilities to identify routes through various pedestrian environments.

2. Background and Related Art

Transportation routing problems attempt to find optimal solutions for routing and location problems within a network. Since the shortest route is constrained by the network, the algorithms for solving for the optimal route must compute actual travel conditions in order to accurately estimate optimal travel routes. For instance, when modeling traffic, algorithms should account for one-way streets, traffic signals, and congestion. Automobile routing applications use distance and/or travel time as the primary impedance (or the cost to traverse an edge). They may also include other network phenomena such as one-way streets and turn impedances. However, such applications do not consider physical attributes such as the make and model of the automobile in route. A station wagon, for example, would use the same route as a mid-size truck. When routing pedestrians, however, it is critical to account for the unique physical ability of the user.

For many people with disabilities (“PWDs”), even short trips to work, to go shopping, or to places of recreation can be difficult. Many barriers that are imperceptible to many people may hinder or totally restrict access to PWDs. Examples of such barriers may include uneven pavement slabs, cobblestone courts and gravel. Consequently, there has been a move towards utilizing geographic information systems (GIS) and global positioning systems (GPS) to assist disabled persons in navigating through space. GIS routing applications have been developed that are similar in their system design and functionality. Some of these applications provide wheelchair users with up-to-date, detailed, customized information to assist PWDs in planning and managing their mobility within urban areas. They also allow users to select an origin, a destination, and some route specifications such as allowing the user to select preferred pathways between two or more locations.

These applications are limited in several respects. One reason for this is that the applications are specific to wheelchair users. Because the data sets and the algorithms in these applications are constructed specifically for wheelchair users, there is no consideration for routing ambulatory people or those who merely use a walking aid. The second limiting factor is the choice of technology to implement the routing applications. The cost to purchase the software is extremely high; therefore, the users are limited to those who can afford the software. Thus, these applications limit their user base through software inaccessibility and the specificity of their routing subjects.

The Web is increasingly becoming a common medium for both the transmittal of aspatial and spatial information, because it provides a degree of accessibility to the public that software packages cannot offer (e.g., MapQuest at www.mapquest.com, MapPoint at http://mappoint.msn.com and Vindigo 5 at www.vindigo.com.)

Maps have been made to assist the individuals in navigating though spatially related points, but the methodology for deriving optimal pedestrian routes is very elementary. Time and distance are among the most common factors for pedestrian routing and navigation; however, a third possible limiting factor is the physical ability of the pedestrian.

There are several limiting factors in determining the correct and feasible path of travel for people with disabilities (PWDs), but an individual's physical ability level is the essential consideration in determining a feasible route. As way of example, individuals with disabilities who would like to traverse an urban environment are required to inquire appropriate geographic routes from live persons at disability centers. Thus, if a person with a disability wanted to traverse an urban environment, to find the most appropriate route, the disabled person would have to contact the disability center and acquire, from a live person, information about navigating. Such disability centers rely on a combination of paper maps and expert knowledge to assist the disabled person in finding optimal routes between spatially related destinations. In some cases personal accompaniment is necessary to make sure that the individual arrives at a desired destination. Although this procedure has been adequate for its intended purpose, it has several drawbacks. First, it is both difficult and costly to maintain paper maps. Second, this method relies heavily on the availability and knowledge of experts. This increases the time required to generate optimal routes and limits the ability to share the information with the community. These factors contribute to high costs with respect to time and money and are susceptible to error. Such structuring is common with other urban environments with similar limitations.

Another consideration in moving within an urban environment is the lack of data. Current paper maps show the location of stairs; however, they do not include other obstructions that may hinder or prevent a disabled person from passing, such as curbs and deep gutters. Theoretically, a paper map could be made to include all of the factors listed above, although even people who have studied a map well are still likely to make large errors in route estimations. Time and other resources can be saved if a route-finding application is developed that considers all the factors necessary for navigating both disabled and ambulatory pedestrians in urban environments. Moreover, it ensures that PWDs are able to locate accessible parking stalls, discover a feasible path of travel, and identify accessible building entrances.

Thus, while techniques currently exist that are used to provide spatial transportation routing by finding optimal routing and location, challenges still exist. Accordingly, it would be an improvement in the art to augment or even replace current techniques with the present invention.

### SUMMARY OF THE INVENTION

The present invention relates to systems and methods for using a Web-based navigational tool, to assist people of varying physical ability levels in identifying routes through urban environments. Some embodiments identify appropriate routing based on user input. Some embodiments of the invention then return a fast, accurate route and its distance. Some embodiments of the invention are designed to assist both local authorities and disabled groups by providing a fully interactive route-finding application. One embodiment of the present invention utilizes the interface functionality of JavaScript while incorporating the optimal display properties of SVG. This software combination produces a high-quality interactive Internet mapping application.

Some embodiments provide a Web-based routing application that solves for a path, including the shortest path, as defined by user inputs. In some embodiments the user inputs physical ability level, origin, and destination. Some embodiments of the invention allow users to select an origin, a destination, and an ability level. In one embodiment of the present invention a user may choose which of three options best matches their ability level: ambulatory, ambulatory with aid, or disabled.

Some embodiments utilize both secondary data as well as data collected explicitly for preferred embodiments of the present invention. Some embodiments provide routing information based on urban pedestrian infrastructure from dirt paths to constructed sidewalks and stairs. Accordingly, some embodiments of the data model designed for this application must be robust enough to consider all possible structural obstructions.

Some embodiments of the route-finding algorithm utilized by the present invention utilize a subnetwork to determine if a path exists. If so, the application determines the shortest path considering the physical limitations of the user. One embodiment of the invention accounts for only structural obstructions. In another embodiment, the design considers temporary obstructions such as building and road construction or destruction as well as permanent structures. Further embodiments consider spatial and path mapping of building interiors and shortest path considerations taking these mappings into consideration.

In some embodiments of the invention, alternative databasing structures are used depending on the relative importance of data redundancy and run-time efficiency in a given situation.

While the systems and methods of the present invention have proven to be particularly useful in the area of providing spatial directions to the disabled community, those skilled in the art can appreciate that the methods and processes can be used in a variety of different applications and in a variety of different areas of manufacture to yield beneficial results.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a graph and its formal representation;

FIG. 2 illustrates an example of intersecting pedestrian transportation networks;

FIG. 3 illustrates a representation of a planar intersection within a relation;

FIG. 4 illustrates network representation of street intersection (a) single node representation (b) expanded representation;

FIG. 5 illustrates a UML diagram of the essential model used for the present invention;

FIG. 6 illustrates a database representation of a directed network;

FIG. 7 illustrates the study area for one embodiment of the present invention;

FIG. 8 illustrates an example of only using selected edges;

FIG. 9 illustrates an example of the data transformation process;

FIG. 10 illustrates an example of node placements to delineate stairs;

FIG. 11 illustrates an example of an identifying feature tool;

FIG. 12 illustrates an example of a locator map;

FIG. 13 illustrates an example of navigational tools;

FIG. 14 illustrates an example of a routing tool;

FIG. 15 illustrates an example of a route between the Union and Kingsbury Hall on the University of Utah campus;

FIG. 16 illustrates an example of an ambulatory route between the Union and Kingsbury Hall on the University of Utah campus;

FIG. 17 illustrates an example of an-ambulatory route between Fine Arts Building and C. Roland Christian Center on the University of Utah campus; and

FIG. 18 illustrates an example of a disabled route between Fine Arts Building and C. Roland Christian Center on the University of Utah campus.

### DETAILED DESCRIPTION OF THE INVENTION

The present invention relates to systems and methods for routing and navigating persons of varying physical abilities between spatially related points. In particular, the present invention relates to systems and methods for using a Web-based navigational tool, to assist people of varying physical ability levels in identifying feasible routes through urban environments.

For the purposes of this application impairment is any loss or abnormality of psychological, physiological or anatomical structure or function. This refers to physical or cognitive limitations that an individual may have, such as the inability to walk or speak.

For the purposes of this invention disability is any restriction or lack of ability (resulting from an impairment) to perform an activity in the manner or within the range considered normal for a human being. This describes a functional limitation or activity restriction caused by impairment. Disabilities are descriptions of disturbances in function at the level of the person. For this project, the functional limitations or activity restrictions are imbedded within the network model.

For the purposes of this invention handicap is a disadvantage for a given individual, resulting from impairment or a disability that prevents the fulfillment of a role that is considered normal (depending on age, sex, social and cultural factors) for that individual. This refers to specific events. For instance, some people struggle to read road signs in the dark. By definition, when they drive in the dark, they have a handicap. If they drive during the day, however, they would not be considered handicapped.

Some embodiments are comprised of a Web-based navigational tool that allows users to obtain optimal routes according to their individual needs. In some embodiments in addition to the user being able to specify an origin and a destination, the present invention also allows the user to specify a physical ability level, which is used to determine which links in the network are feasible for that ability level.

Some embodiments are designed to assist local authorities and disabled groups to identify feasible routes in pedestrian environments. Preferred embodiments provide a fully-interactive route-finding application that PWDs can use to assess routes through pedestrian areas including urban and suburban areas that best match their individual needs. Some embodiments comprise minimum data requirements for collection and maintenance, strategies for spatial network databases, two models for constraint handling, a shortest path algorithm implementation, and an effective user interface. In some embodiments, the three main software components to the success of the present invention are the World Wide Web, GIS, and the Java 2® environment. In preferred embodiments the Web is utilized as the interface between users and the database. In preferred embodiments a GIS provides a platform for efficient data collection, compilation, and storage of geographic data. In preferred embodiments the back-end is composed of a Java application that accepts three inputs from the user, and then returns the list of edges that compose the optimal path.

Some embodiments (1) determine an efficient way to store a graph to reduce the path-finding computation time, and (2) utilize the Web as a medium to route pedestrians. In some embodiments graphs are stored in a forward star structure (FSS), which is well suited for finding the neighbors for a specified node. In other embodiments the graphs are stored in adjacency matrix which is well suited for searches if an edge exists. In preferred embodiments the data structure utilized is a hashmap data structure in combination with two constructed objects, a node object and a neighbor object. This provides efficient searches for neighbors and offers the advantage of connectivity.

The present invention contemplates utilizing a variety of choices of obstacles represented within a geographical environment. For example obstacles may include steps and curbs. The list of urban barriers in some embodiments may comprise things such as slope, surface roughness, narrow pavements, uneven paving slabs, raised manholes, street furniture, handrails and congested pavements. If any of these obstacles prove to be hindrances to PWDs in pedestrian environments the present invention could be adjusted to include them.

Another embodiment of the present invention may include the ability to route through buildings. This would be especially helpful for disabled students who are traveling on a large pedestrian network built on a hillside. Traveling through a building could reveal locations where a PWD could use an elevator instead of traveling around a building through a series of ramps.

A logical framework for integrating the two-dimensional data of the sidewalks with three-dimensional data of buildings is within the scope of this invention. Node-relation structure (NRS) expands upon the concept of primitive spatial two-dimensional vector objects (point, line, and polygon) to include three-dimensional objects such as a cube, sphere and cylinder. This may be accomplished by expanding upon graph theory and generating a multidimensional graph that allows for three-dimensional geometric network model representation. This data model demonstrates that a system can be created that analyzes the complex connectivity relationships among three-dimensional objects in pedestrian environments using an adapted algorithm.

Another embodiment of this application may include the ability to dynamically route pedestrians. For example, if travel on a particular sidewalk would be prohibited due to a maintenance procedure, the present invention could be modified to route people differently during the temporary blockage. Automatic Vehicle Monitoring (AVM) is a prototype that enables radio communication among wireless devices, communication software, GPS, GIS, and access to databases which integrates spatial data with non-spatial data. This enables vehicular monitoring in real time and visualizations on the map. If AVM were combined with the present invention, users could know of vehicular obstructions in real-time.

Some embodiments utilize Scalar Vector Graphics (SVG) for data presentation and Java® based technologies route computation. In some embodiments SVG provides optimal display functionality by means of vector technology and offers a set of powerful querying tools which are based on eXtensible Markup Language (XML). As a result, some embodiments are able to generate fast, correct paths of travel for all people who have access to the Web. Some embodiments also capitalize on the speed and efficiencies of Java's object oriented technology for optimal route computation.

Some embodiments allow users to select an origin, a destination, and an ability level. In one embodiment of the present invention a user may choose which of three options best matches their ability level: ambulatory, ambulatory with aid, or disabled. The present invention then returns a fast, accurate route and its distance. Some embodiments are designed to assist both local authorities and disabled groups by providing a fully interactive route-finding application that identifies shortest feasible routes.

One embodiment of the present invention provides a Web-based routing application that solves for the shortest path as defined by user inputs. Examples of such inputs are physical ability level, origin, and destination. The urban pedestrian infrastructure varies greatly from dirt paths to constructed sidewalks and stairs. Thus, in some embodiments the data model designed for this application is robust enough to consider all possible structural obstructions. To solve for the optimal route, the application eliminates all network edges that are not affordable to the user. The route-finding algorithm of some embodiments, use this subnetwork to determine if a path exists. If so, the present invention determines the shortest path considering the physical limitations of the user. This ensures that the user will be physically able to traverse the provided route. One embodiment of the invention accounts for only structural obstructions. In another embodiment, the design considers temporary obstructions such as building and road construction or destruction as well as permanent structures. Further embodiments consider spatial and path mapping of building interiors and shortest path considerations taking these mappings into consideration.

In one embodiment of the invention, alternative databasing structures are used depending on the relative importance of data redundancy and run-time efficiency in a given situation. One major issue to address in the database design process is the trade-off between data redundancy and run-time efficiency. If redundant data exists within the data base, every instance must be updated. Thus, when a record needs to be updated, there is no easy way to check if all instances of that record have been updated. Thus, redundant data have the potential to lead to database inconsistency; on the other hand, redundant data can enhance the efficiency of the optimal path algorithm, and therefore reduce the time necessary to return the result to the user. Since spatial infrastructures change frequently, the data set needs to be updated regularly. Thus, the need for eliminating redundancies is great. However, because for the purposes of one embodiment of the present invention the audience is Web users, the primary concerns for this embodiment of the application are speed and efficiency.

Some embodiments are flexible enough to adapt to future needs, and this invention may use multiple alternative databasing structures that would facilitate various future needs. The data model for one embodiment of this invention accounts for only a single routing constraint, namely, the user's physical ability level. However, in the future there may be a need to expand the data model to include other constraints such as slope, or possibly even a roughness factor for wet conditions. Accordingly, the updatability of the data model is another consideration in addition to speed.

There are several possible solutions when selecting a data model. One example is to adopt the legacy data model. This solution attempts to incorporate and modify existing data and data structures to fit the current application. The major advantage of legacy data models is the lower cost of collecting and acquiring data. Another example is a custom data model solution. This solution optimizes the data model in order to maximize efficiency during run time, with very little consideration regarding the cost of development. Yet another example is to combine the legacy and custom data models. This entails translating existing data into a custom data model using either the import/export functionality of existing software or coding a new data model. The detailed description of the present invention discloses preferred embodiments of data structures and rationale for their selection. Thus, while the present invention contemplates preferred embodiments, those embodiments are not to be construed as limiting in any way.

Some embodiments utilize both secondary data as well as data collected explicitly for preferred embodiments of the present invention. One embodiment of the present invention uses secondary data from several formats. As way of example, urban infrastructure may be in Computer Aided Design (CAD) format. Other data may exist in Environmental Systems Research Institute, Inc. (ESRI) coverage format as well as ESRI shape files. However, when geographic data are gathered from several sources, they are likely to be of differing accuracies. Therefore, one must aggregate the data in order to merge data sets. Contents of the data sets may include sidewalks, buildings, parking lots, bridges, and playing fields. Certain data may need to be transformed into a data format more suitable for Internet mapping.

In addition to existing data, some embodiments also include procedures for collecting primary data. Some elements collected include, but are not limited to, the start and ending points for stairs, curb cuts, accessible building entrances, and handicapped ramps. This data can be obtained via the Global Positioning System (GPS) or through remotely sensed (RS) data.

In one preferred embodiment, the data may be accumulated and assembled within a GIS. In some embodiments an automated link transformation from the network representations in a GIS data format to a data format that is more suitable for Web mapping. For example, in preferred embodiments a SVG dataset is created. There are several advantages to creating and maintaining data within a GIS. First of all, GIS is a convenient and efficient platform to integrate multiple geographic data formats. Secondly, GIS are suitable for expansion of data attributes, like adding a texture index to surfaces. Lastly, it provides quality control tools for editing nodes, edges, and maintaining topology. Data acquisition and the data modeling procedures are closely related. Therefore, the present invention contemplates the above mentioned solutions for data acquisition with respect to the possible data models in order to derive an effective and efficient partnership.

In one embodiment of the present invention the algorithm takes three parameters as input: a starting point (the origin), an ending point (the destination), and the physical ability level of the user.

In some embodiments there are at least two basic approaches for modifying shortest path algorithms to incorporate route restrictions when searching for an optimal route. One option entails an evaluation of each edge as the program “relaxes” its neighbors. When the program relaxes a node, it finds all the nodes connected to the current node, calculates their respective distances, and then adds them to a sorted queue. This approach adds an additional step within the relax neighbor function by evaluating if the edge between the two nodes is traversable. The additional cost to the algorithm is equal to the number of edges evaluated. Even though this method adds an additional step during computation time, it is necessary so that any links that the user cannot traverse are excluded.

A second method of incorporating route restrictions within a network is to eliminate all edges that violate the travel restrictions prior to beginning the program. Once it is determined which edges are eligible for travel, the program must rebuild the topological relationships to ensure proper connectivity. The benefit of this approach is that the shortest path algorithm operates only on affordable edges, meaning the smallest network possible given the ability level of the user. This reduces the number of edges examined, thus leading to a reduction in computation time. Consequently, the total time for considering the restrictions is the sum of the time necessary to eliminate the edges that violate the restrictions, plus the time to rebuild the topology, plus the runtime of the shortest path algorithm. In comparison with the previously mentioned method, the computational time is reduced. However, the total time savings is dependent on how many edges are eliminated during the preprocessing. Although, both of these constraint-incorporated approaches produce an optimal path in an acceptable amount of computational time other approaches are also suitable for Internet usage.

A graphical user interface (GUI) that has three general functions: to receive inputs, display results, and be accessible to the general community, interfaces between the user and the database. In some embodiments the GUI receives, on the front end of the application, inputs from the user such as: their physical ability level, the origin and the destination. On the back end, the GUI plays the critical role of displaying the correct affordable route. The results are displayed in a manner that is understandable to users.

The remaining disclosure of the present invention is grouped into three subheadings, namely “Theoretical Underpinnings for the Navigational System,” “Methodology” and “Examples.” The utilization of the subheadings is for convenience of the reader only and is not to be construed as limiting in any sense.

### 1. THEORETICAL UNDERPINNINGS FOR THE NAVIGATIONAL SYSTEM

This section reviews in detail some theoretical areas that underlie this invention. Theoretical concepts discussed below include: graph theory and how it relates to network modeling at both the logical level and the physical database level; graph theory applied to shortest path algorithms; categorization of differing ability levels (e.g., the World Health Organization's (WHO) definitions of physical abilities to group pedestrians into one of three categories: disabled, handicapped, and ambulatory; however, other classification systems may be used without deviating from the present invention); a discussion on affordance theory and how it is used to provide a theoretical framework to connect the real world to the data structure used for the present invention.

Graph theory is the mathematical foundation for network data structures. Graph theory is a subfield of discrete mathematics that provides a basis for analyzing topological properties between members of a set. A graph is comprised of two basic elements: vertices and edges. Vertices are typically represented by an integer, edges are constructed using the labels of the vertices to which they connect. Graph theory provides a foundation for network analysis.

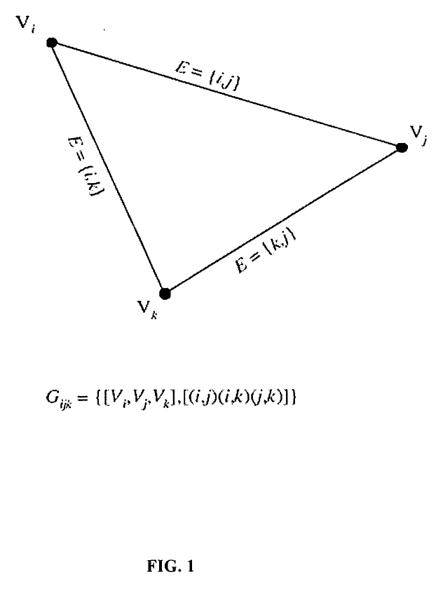

The mathematical representation of networks is rooted in graph theory. Graph theory observes the relationships between members of a mathematical set. A graph consists of a discrete set of vertices (V) and a discrete set of edges (E). Vertices (V) are also referred to as points and are represented in the graph by a unique integer. Edges, sometimes known as arcs or line segments, represent the physical link among vertices. Therefore, a graph is formally defined as G=[V,E], where V is a set of unique vertices and E is defined by a pair of vertices such as this: E={i,j}. See FIG. 1

Graphs have two main properties that make them well suited for representing transportation systems, including pedestrian systems. The first property is that self-loops cannot exist within a graph (edges that begin and end at the same vertex). The second is that they inherently carry the property of direction. An edge is defined by two vertices {i,j}, having a starting vertex at i and an ending vertex j. Thus, it is not necessarily the case that {i,j}={j,i}. However, if this relationship is true, the edge is said to be undirected. If all the edges within the graph are undirected, then the graph is referred to as an undirected graph. Likewise, if all the edges in the graph have directions associated with them, it would be called a digraph. A graph that has both directed and undirected edges is often called a mixed graph. It would logically follow then that a mixed graph could be converted into a directed graph by replacing every undirected edge {i,j} with a pair of directed edges {i,j} and {j,i}.

Most transportation networks are also known as planar graphs. A planar graph by definition is embedded within some mathematical plane. Thus, whenever two edges cross, there must be a vertex. This does not allow for edges to “float above” one another, such as in the case of a bridge. However, it does permit the addition of nodes to represent topological features that may exist between two network intersections. For a pedestrian network, this could be a staircase. While there would not be an intersection per se, there could be a change in terrain that could be modeled with nodes, such as the beginning and ending of a staircase.

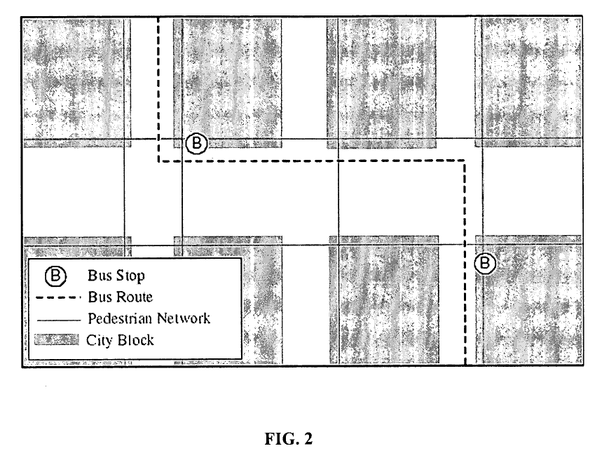

Many routing applications operate under the assumption that all topological graphs exist in a single plane. This assumption limits optimal route finding solutions to two dimensions; thus, the data model limits the modeling capabilities within the given application. This problem becomes very apparent when attempting to model flow over or under bridges. From the planar view, two sidewalks could appear to intersect; however, the real world environment might tell another story. An embodiment of the present invention integrates multiple transportation systems. Pedestrians who enter the network can do so only at specific locations. If they arrive by bus, they enter the network at a bus stop, and if they arrive by car, they enter at a parking lot. FIG. 2 shows the bus route intersecting the pedestrian network at four locations in space; however in reality, the bus only stops at the bus stop.

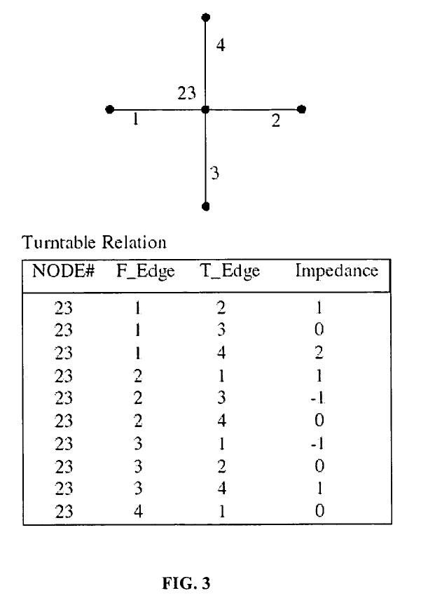

Most GIS and other routing applications have “workarounds” such as turntable relations. Turntables are used to explicitly define the relationships between adjacent links and possible impedance values at network intersections. In the case of FIG. 3, the graphic representation portrays a planar intersection. However, the impedance values in the turntable allow the data model to represent nonplanar features while only showing two dimensions. In this instance, if a turn were not possible, perhaps due to a bridge, the impedance would be given a negative value or similar designation. If the turn is possible, then it is either given an impedance value of 0, or similar designation, meaning that it is possible without cost, or a positive number, or similar designation, which would represent the average time it takes to traverse from one edge to the next.

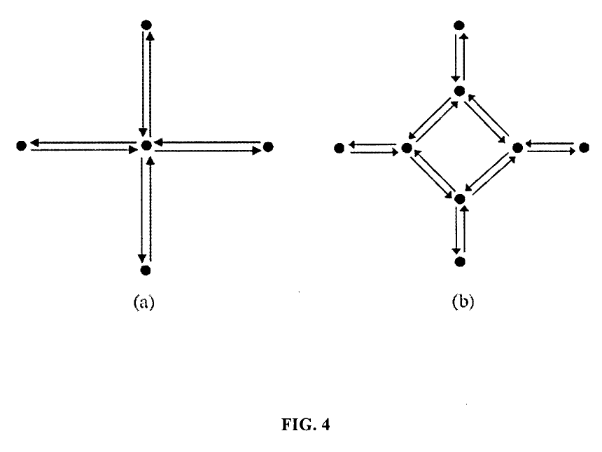

The two other common ways to represent non-planar intersections in data models are: an expanded intersection representation and the relaxation of topological rules. A diagram of the expanded intersection is shown in FIG. 4. The expanded intersection option replaces every node with four new ones and then connects those with twelve additional directed edges. Although this method captures all the necessary turn properties of the intersection, it greatly increases the size of the database due to the additional data per intersection. The other option is the relaxation of the topological rules of the data structure. This may not necessarily require a vertex wherever two or more edges meet.

Spatial network databases (SNDB) form the kernel of many applications such as transportation planning, air traffic control utilities, river transportation and irrigation canal management. Unlike traditional spatial databases where objects are based on the spatial proximity, SNDB are based on proximity and connectivity. The shift from only proximity to connectivity requires new and different database techniques for data modeling, query languages, and indexing.

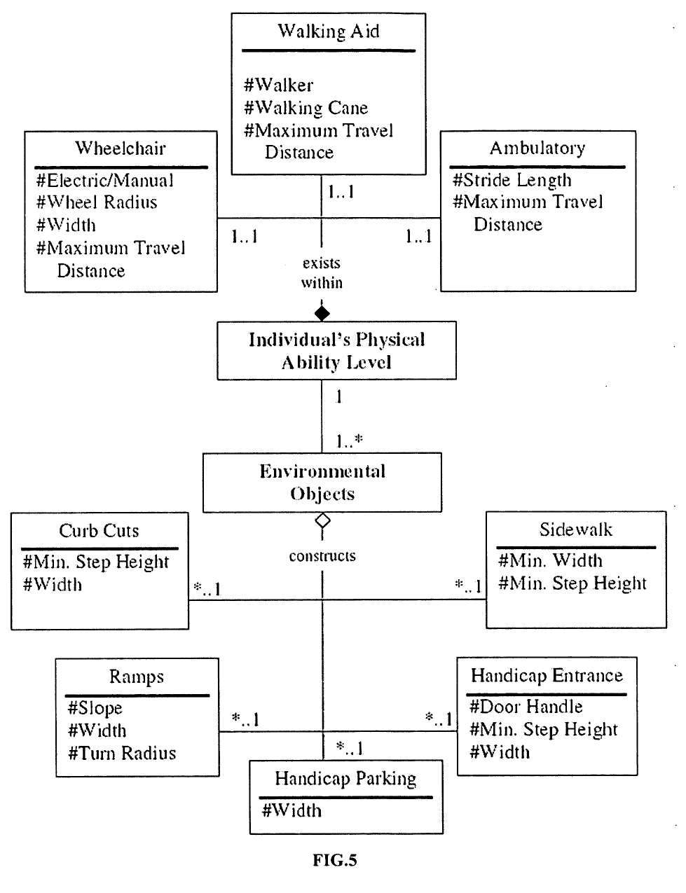

At the conceptual level of data modeling, all the available information related to the application is organized using a high-level semantic modeling technique. The focus at this point in the modeling is on the data types, their relationships and any of their constraints. FIG. 5 shows a Universal Modeling Language (UML) diagram of the essential environmental elements and their relationships, as recommended by the Open GIS Consortium's (OGC. Note that all environmental objects must be topologically related to the pedestrian network of sidewalks.

The logical modeling phase relates the actual implementation of the conceptual data model to a database management system (DBMS). The relational model is the most widely implemented model in current commercial databases. Relational databases can answer any query expressible in relational algebra, which is the universally accepted model for traditional applications of relational database.

The basic operations used with graph theory are based on the three fundamental subclasses of graphs: graph, vertex, and edge. The graph class must be able to add a vertex or an edge, delete a vertex or an edge, return a vertex or an edge given two vertices, return an adjacent node of a given vertex, find all adjacent neighbors, and lastly, return the parent of a given vertex. The vertex class necessitates four basic operations: the creation of a vertex with the appropriate label, returning a label associated with a given vertex, and marking a vertex as having been visited. The edge class is comprised of a constructor and it has three methods: to return the first node of the edge, to return the end node of the edge, and to return the length of the edge. Again, though this is not an exhaustive list of operations for SNDB, it contains elements as may be incorporated into an embodiment of the present invention for connectivity and shortest path.

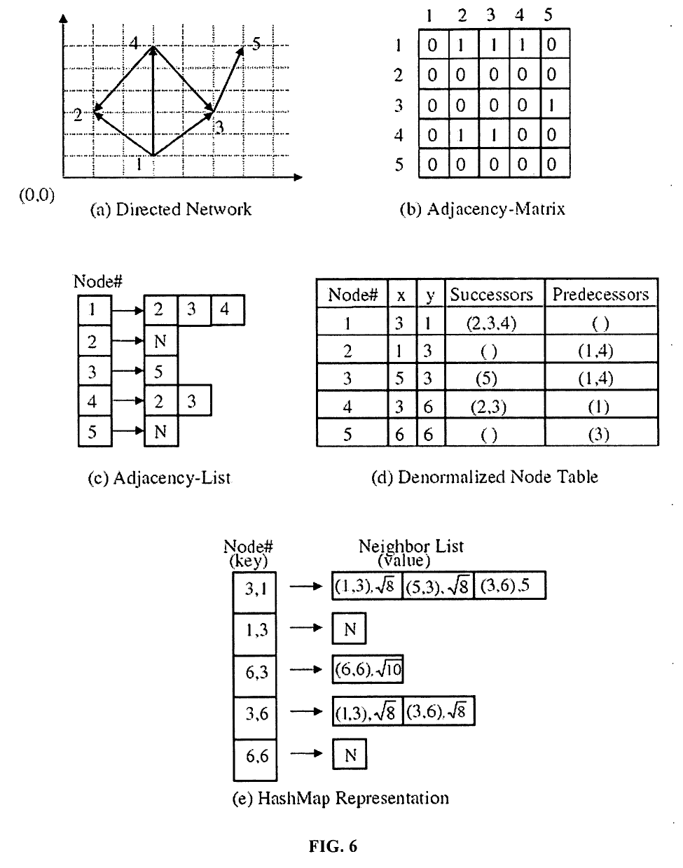

The physical data modeling phase has at least two well-known main-memory data structures for implementing graphs, namely, adjacency-matrix and adjacency-list. FIG. 6(a) provides a directed network that is used to demonstrate how each of the following methods is implemented. The adjacency-matrix is constructed into rows and columns. There is a column and a row for each vertex. The matrix entry is 0 or a similar designation if there is no edge between the corresponding vertices, or 1 or similar designation if an edge does exist (see FIG. 6(b)). The matrix entry can also be used to record any impedance for traversing the edge. This structure is efficient for answering edge queries such as, ‘Is edge (u,v) in graph G?’ The adjacency-list structure is an array of pointers. Each element of the array corresponds to a vertex on the graph, and the pointer points to a list of successors of the vertex (see FIG. 6(c)). This particular structure is well suited for enumerating queries such as, “Find all neighbors of vertex v.” This data structure is efficient for an iterative process; however, it is inefficient for a searching for a specific element within the data set. There are also several modifications of these basic data models which help decrease the shortest path computation time. One method is to have a denormalized relation that contains coordinates, a list of successors, and a list of predecessors (see FIG. 6(d)).

An embodiment of the present invention uses a hashmap data structure to represent the pedestrian network (see FIG. 6(e)). Unlike the array list data structure that is designed for fast iteration over the data, the hashmap data structure provides an efficient means for the look-up process. The look-up time for a hashmap is three times faster than the look-up time for the array list data structure. The hashmap is more sophisticated in that it stores some key information along with some associated information (or the value). The hashmap used for the present invention stores node objects as the key value (a node object is constructed with an x and y coordinate) and the associated information, or the map value, is a list of neighbor objects (a neighbor object is constructed using a node and an integer). FIG. 6(e) provides an illustration of this data structure.

An embodiment of the present invention utilizes the hashnap representation for at least two reasons. The first reason is that the number of steps needed to obtain the forward star of a node and its associated distances are reduced from three steps to one. With this hashmap data structure, when a key value is called (a node in this case), all the nodes connected to that node are returned with their respective distances; this is its forward star. The second factor for choosing the hashmap data structure over the adjacency-list is that the hashmap data structure random access time is three times faster than that of an arraylist data structure. By using the hashmap data structure in conjunction with node and neighbor objects, the number of steps to retrieve the forward star is reduced by two steps. A second advantage to using the hashmap data structure is that it takes one-third the time to retrieve an object in a hashmap compared to an array list.

In some embodiments, in order for an optimal path finding application to return realistic solutions, the application considers both network impedances and edge directionality. The edge impedance is an attribute within the data model that represents the actual travel cost. In most transportation models, the impedance value represents the time necessary to traverse the length of the edge. However, in the instance of pedestrian networks, the impedance is the length of the edge, thus producing the solution in distance (feet, meters, etc.) as opposed to the more traditional result of time (seconds, minutes, hours, etc.).

In some embodiments, directionality also plays a critical role in finding optimal routes. For example, one way streets exist in most street networks. The data model may incorporate this phenomenon and consider that the cost of traversing an arc may differ depending on the direction traveled. This is seen in most cities during rush hour. In some embodiments, these problems can be modeled by assigning directionality. In some embodiments, the edge direction is defined by the sequence from the start node to the end node, or the end node to the start node. In an embodiment of the present invention, a single edge represents the same street twice, allowing the impedances to be independent of each other. Specifically, if travel is not permissible in a particular direction, the impedance attribute for the edge in that direction is set to infinity or a similar designation, symbolizing the impossibility of traversing the edge. However, in pedestrian networks, while sidewalks are not defined as one way, their impedances need to be independent in order to distinguish whether the flow is going uphill or downhill. The directionality can also vary depending upon the physical ability of the pedestrian. For example, the uphill impedance value would be lower for a person who can walk than for a person who uses a wheelchair.

In some embodiments, in addition to adding an edge impedance to better model the real world transportation network, some transportation data models use nodal impedance. Nodal impedance allows transportation models to account for the cost of making turns at intersections. For example, there is often a higher cost associated with making left turns than right ones, and there is typically a greater delay while waiting at a stop light than a stop sign.

At the heart of all optimal path finding applications are algorithms for solving the routing and location problems within a network. This section examines shortest path algorithms utilized in some embodiments of the invention for one unit of flow through the network, meaning that the effects of multiple units traversing the network are not examined. Thus, in some embodiments the edge weight is static and not a function of all flow that use that edge. For some embodiments, there are two other considerations that must be made prior to exploring algorithms in detail. First, the shortest path from a defined origin to a defined destination must be composed of the shortest paths between all intermediate locations. That is to say, if the shortest path solution between nodes i and j includes a mid-point k, then the path from i to k and from k to j must also be the optimal route. The second fundamental property of shortest path algorithms is that they cannot be computed using a “greedy” approach. The optimal solution cannot always be found by selecting the smallest (least cost) edges from any node. Thus, the algorithm must be able to look ahead to see if lower cost edges exist at the end of a high cost edge. Shortest path algorithms look forward to seek high cost edges by treating the estimated shortest path from an origin to each intermediate node as a temporary guess. This allows the algorithm to go back and change the solution if a shorter path is found.

With respect to the above mentioned criteria for shortest path algorithms, in some embodiments this algorithm uses an iterative process to build a shortest path tree (SPT) for the network. The tree is rooted at the desired origin and has leaves representing all reachable nodes within the network. More formally, the solution is stated as the SPT rooted at r or 7*(r). All shortest path algorithms use the same fundamental operations; however, they differ with respect to the physical level of implementation, or how the data structure is designed. Thus, it is important to examine both the algorithm operations and the implementation strategies. For a graph defined as G=(N, A) and a nonnegative arc weight wᵢⱼ for each (i,j)_A, the following steps outline the algorithm for finding the shortest path in some embodiments of the present invention.

Step 1. Initialize a directed tree rooted at node r, T(r). For each v_N, let l(v) be the length of the path from r to v using subnetwork T(r) and let p(v) be the parent node of v in T(r).

Step 2. Find an arc (i,j)_A such that l(i)+wᵢⱼ<l(j), set (i)=l(j)+wᵢⱼ and update T(r) by setting p(j)=i.

Step 3. Repeat step 2 until l(i)+w_{ij —}l(j) for every (i,j)_A.

There are four main storage elements to Dijkstra's shortest path algorithm utilized in some embodiments. The first stores the best estimate of the shortest distance from the source to each vertex, d. The second storage P, also known as the parent, or predecessor tree, stores the predecessor of each vertex on the shortest path from the source. The third data set is S, the set of settled nodes, or those nodes whose shortest distances from the source have been identified. Lastly, there is Q, which represents the set of unsettled nodes.

With the fundamental building blocks defined, the high-level description of Dijksta's SPT algorithm involves three steps. The three steps are (1) while Q is not empty, extract the node with the minimum distance (u) from Q, (2) and add u to S, (3) relax the neighbors of u. When the program “relaxes” a node, it finds all nodes connected to the current node, calculates their respective distances, and then adds the nodes to a queue of sorted nodes. This insures that Q contains a sorted list of nodes that do not already exist in data set S and the distance is defined in data set d.

Given the size of many geographic information databases, the smallest difference in the efficiency of an implementation can result in large savings in practice. Three main areas can be modified to suit the needs of the specific network: (1) the network storage structure, (2) the labeling method, and (3) the selection rule/node processing structure. Network storage structure refers to the actual data model, or how the information is stored on the hard disk. This includes the relationship between memory locations and their respective pointers which allows for efficient retrieval of relevant information. The labeling method is the manner in which the program keeps track of which nodes have been scanned. The decision rule/node processing structures determine the next node for examination. There is a direct relationship with the selection node and the labeling method.

The forward star structure (FSS) is known for being an efficient network data storage structure. The FSS data structure consists of three arrays, namely, an arc array, an arc weight array, and a pointer array. The pointer array is used to access the two data arrays. The arc array is organized in a specific sequence beginning with node 1 (for example, nodes 1,2,3, . . . are ordered sequentially). The set of arcs leaving that from-node are known as the forward star of that node. The arc weight array is ordered in the same order as the arc. For example, if the program called for the arc at position 7, the corresponding weight in the weight array would also be at position 7. The pointer array allows access to both of these data structures.

Storing the network in an array structure has its advantages, but may have slow access time. Therefore, a different data structure is used in some embodiments of the present invention. The network is stored in Java's hashmap data structure which allows for extremely fast random access. The hashmap stores key/value pairs; this allows the program to quickly find an existing value if the key value is provided. The graph is stored in the hashmap as follows: the key value holds node objects (which are similar to the second array data structure in the FSS) and the value field stores a linked list of neighbors (similar to the first array in the FSS). A neighbor object is defined by a node object and an integer representing distance. Edges are implicitly defined as objects containing a start node, an end node, and a distance. Thus, when the program needs to locate all possible destinations from node u, it calls for a key value u from the hashmap. The hashmap then returns the forward star of u. This data structure uses the basic concept of the FSS; however, the number of steps for retrieving neighbors is reduced from a three-step process using the array structure to a single step using this hashmap structure.

The second implementation issue is the labeling method. There are three labels maintained for each node i visited, namely the shortest distance from the source node, the parent node, and a status label. For this application, each labeling function uses a variation of the bucket strategy to store labels. The bucket storage method consists of two components. The index is a set of elements that contain a range of values that exist within individual buckets. A bucket is an aggregate memory unit that stores data with similar values. This strategy reduces the search to a few buckets instead of an entire list. The three labeling functions consist of the following. The first is the shortest distance for each node visited, d(i), from the source node (s). The second label holds the parent node (also known as the predecessor node), p(i). The last labeling function maintains the visiting status of the current node, S(i). The node status contains one of the following labels: i) unreached, ii) temporary or iii) permanent. The shortest distance function creates and maintains the hashmap d. d is a hashmap that uses the node object as the key value and uses the shortest distance from the source node (u) as the value. When d is initialized, the distance for each node is set to infinity. During the runtime of the algorithm, if a shorter distance is found, the function replaces the initial value of infinity with the newly computed distance. This ensures that at the completion of the algorithm the shortest distance is assigned to each node.

The second labeling function produces the predecessor tree, a tree spanning the graph that yields the actual shortest path. The predecessor tree stores a relationship between nodes, specifically, the current node and its predecessor. Since the mapping between the nodes is one-to-one, the hashmap data structure is again used. The current node u is stored as the key value and the predecessor of u, p(u), is stored as the value. This design allows for efficient computation of the route once the destination node is reached.

The third labeling function, the settled nodes set (s), is relatively simple compared to the last two labeling functions. s is implemented using the hashset utility. The purpose for using the hashset data structure is that it offers constant-time performance on the contains operations. The contains operation is a Boolean operation that checks to see if the program has already identified the shortest distance to a node. If it has, the node is ignored; if it is a new node, it is added to the queue. This labeling technique ensures that once the shortest distance is found, it is not considered again. The last implementation issue to discuss with respect to improving Dijkstra's algorithm is the selection rule and node processing. The two aspects that are particularly important to the performance of Dijkstra's algorithm are (i) the strategies used to select the next temporarily labeled node, and, (ii) the data structures utilized to maintain the set of labeled nodes. Some embodiments of the present invention implement a type of queue known as a priority queue. In a priority queue, each element contains a label that is used to determine the priority of the element within the queue. In this particular network, the distance to the next node is used to determine if the node is added to the queue, where in the queue the node is added, and which node is removed. This strategy is called the “best-first” search strategy.

With the implementation issues discussed, the next item to address is the computational complexity of the optimal path algorithm. The asymptotic time of an algorithm is often referred to as the Big-O notation. For example, if an algorithm has an asymptotic time complexity of O(n2), this really signifies that the number of operations is no greater than kn2 for an input size n, where k is some constant. This corresponds to the worst-case scenario. Dijkstra's algorithm using an unordered list (naive) storage structure has a complexity time of O(n₂), where n is the number of nodes in the network. However, in order to make the Dijkstra algorithm run more efficiently, some embodiments of the present invention uses the approximate bucket strategy (a sorted data structure). This reduces the complexity time down to O(m_+n(_+Cl_), where C is the maximum arc length in the network and _ is the maximum number of times that a node can be scanned. By sorting the list as items are inserted, the algorithm can avoid searching through the entire unsorted list of nodes.

Traditionally, transportation network systems are designed to study best routes and capacity constraint problems. The most common subject studied is traffic, where the objects of study within the network are vehicles. For the purposes of some embodiments of this invention, the network under examination is a pedestrian network of sidewalks, and the objects studied are people of varying physical ability levels. Unlike studying vehicles in a network where the type of car is not of concern, when routing pedestrians through urban environments it is crucial to know the physical ability level of the individual.

When a person without disabilities needs to navigate through an urban environment, a simple planametric map suffices. He or she can foresee all reasonable obstacles and pathways, such as buildings, roads, and sidewalks since maps are tailored for an average person's mobility. With the knowledge of the perceived obstacles, the person can then begin locomotion steering into openings and away from obstacles that afford injury or prohibit traveling. While traveling, if the ambulatory person encounters objects such as gravel, steep slopes, steps or small vegetation, they are able to either traverse the challenging terrain or locate an alternative route without too much difficulty. However, people with differing physical abilities levels may travel through the same environment using different routes. Many of the barriers that hinder or restrict access to wheelchair users are imperceptible to able-bodied people. Thus, to a person with disabilities (PWD), objects such as gravel, steep slopes, steps or small vegetation become obstructions that can prevent a PWD from arriving at their destination. A standard planametric map does not supply enough information to identify a feasible route to a person who cannot support locomotion without the help of an aid (i.e. a wheelchair or a walker). Thus, an application providing more information than the current campus map is needed to give PWDs the ability to navigate independently.

Some accessibility standard requirements are binary (i.e., either a building is accessible or not). There are limitations of this standards-based approach and there are alternative measurements of accessibility. One alternative is a measurement of accessibility that is sensitive to both the number of routes and the values of each access route in conjunction with more traditional measures of absolute access. An example of this alternative is a construction of a wheelchair ramp. A wheelchair ramp provides absolute access to a building. However, an alternative placement of the ramp might provide an increase in relative access, while still providing absolute access. A general urban map does not provide PWD's with the same independent mobility as it does to the ambulatory person. The limiting factor is a lack of specific information about the environment, such as stairs and curb cuts. Situations such as this put physically disabled people in on the edge of mainstream society. It is apparent that ambulatory people have the information they need to navigate through campus, however, PWDs do not. As a result, there is a need to develop a navigational system to assist people in finding the necessary information to navigate through urban environments relative to their ability to walk. The present invention provides PWDs the freedom and independence to navigate through urban or suburban environments, especially if it is unfamiliar territory. In order to design a network and a path-finding algorithm to assist PWDs, this invention relies on the theory of affordance in combination with optimal path-finding algorithms to provide users with a personal route dependent upon their defined ability.

Affordances are the allowable actions specified by the environment coupled with the properties of the organism. It is a term that incorporates both the environment and the individual in a two-way partnership or communication. Conventional perception theory is simply the passive sensing of the retinal image. Perception is an act. Affordances are not solely the properties of the environment, but they are jointly determined by the environment and the organism. In other words, an affordance can only be determined or measured in a unique space and time with a unique organism present that can visually perceive ‘things’ in the environment and evaluate them. Affordances do not change as the needs of the observer change. The observer may or may not perceive or attend to the possibilities an environment offers. Yet, the affordance, being invariant, is always there to be perceived. For example, the appearance of a sidewalk may change due to snow or rain, but the physical properties of the sidewalk (being flat, horizontal, rigid, etc.) still afford walking.

There are six main principles of affordance theory:

1. Affordances of an environment are what they offer, what they provide, what they furnish, and what they invite. The environment includes the medium, the substance, the surface with its layouts, the objects, places, hidden places, other people and animals.

2. Critical “values” and “meanings” of things in the environment can be directly perceived by the observer. Values and meanings that afford actions have a reality external to individual perceptions and therefore can be measured or represented.

3. Affordances are relative to the organism. They can be measured only at the ecological scale.

4. An affordance is invariant. The affordance of something does not change as the needs of the observer change.

5. Affordances are holistic. What we perceive when we look at objects are their affordances, not their dimensions and properties.

6. An affordance is a compliment between the perceiver and the environment. It is neither objective nor subjective, and yet both at the same time. It cuts across the dichotomy of the subjective-objective. Affordance can make sense only from the system point-of-view.

One could use an example of a mailbox to demonstrate affordance theory and the complementary relationships between the environment and the organism more clearly. The mailbox is a ‘thing’ that exists in our environment. To a person holding a letter encapsulated by a stamped envelope, a mailbox affords the opportunity to mail the missive. If a person had no concept of a postal system, however, the mailbox offers no affordance to that individual. On the other hand, a person may pass several mailboxes on their way to work, but if they do not need to mail a letter, they do not take advantage of the affordance that the mailboxes offers them. Yet the affordance (or opportunity) is still there.

In the same respect, stairs offer the affordance of vertical and horizontal traveling. One can climb up the stairs or down the stairs to maneuver between floors in a building. However, to someone in a wheelchair, stairs do not offer the same affordance. On the contrary, stairs offer a negative affordance such as pain or injury. In the mailbox example, it was the conceptual understanding of the postal system that distinguished the affordance. In the case of the stairs, the physique of the individual determined the unique affordance between the environment and the person. In both cases the affordance is determined by an individual of a certain ability level in a specific location in space at a specific time.

One may further differentiate affordances into external and internal representations of space. The surrounding environment provides structure and information that define the external space. On the other hand, the internal space of the organism is defined by the structures and mechanisms of the biological, perceptual, and cognitive faculties. The external and internal perceptions of space can be defined by either their constraints or by their allowable actions, but not by both. Constraints are defined by the negation of allowable actions. If affordances are defined by constraints, the affordance would be the union of the external and internal constraints. In other words, all constraints must be satisfied in order for an affordance to exist (see equation 1). If affordances are instead defined by allowable actions, then the affordance would be equal to the intersection of the external and internal perception (see equation 2).
External ∪ Internal=Affordances as defined by constraints Equation 1
External_Internal=Affordances as defined by allowable actions Equation 2

The present invention uses internal constraints, as defined by the user, in combination with the constraints of the environment, as defined within the network model. The present invention applies the user's abilities and his/her internal constraints to derive a suitable path of travel. The advantage to using this approach to perception for routing PWDs is the unique attention paid to the individual user. PWD have limited navigable abilities, and it is very difficult for them to change their predetermined route. Therefore, an application that perceives obstacles prior to the individual perceiving them would be a great benefit to them.

A particular group of people who would especially benefit from this application include those who become temporarily handicapped. For instance, if a man broke his leg or had knee surgery, he would temporarily become handicapped and would perceive his environment very differently. The staircase they previously used would take much longer and would require more effort because they now would have crutches. To the temporarily handicapped person, stairs no longer afford an easy means of travel. Thus, the present invention is designed to assist this person in perceiving their environment differently while they are handicapped.

2. METHODOLOGY

This section examines the six major aspects of the application construction. Each major aspect is discussed in subsection below. Each subsection looks at both the design and implementation decisions.

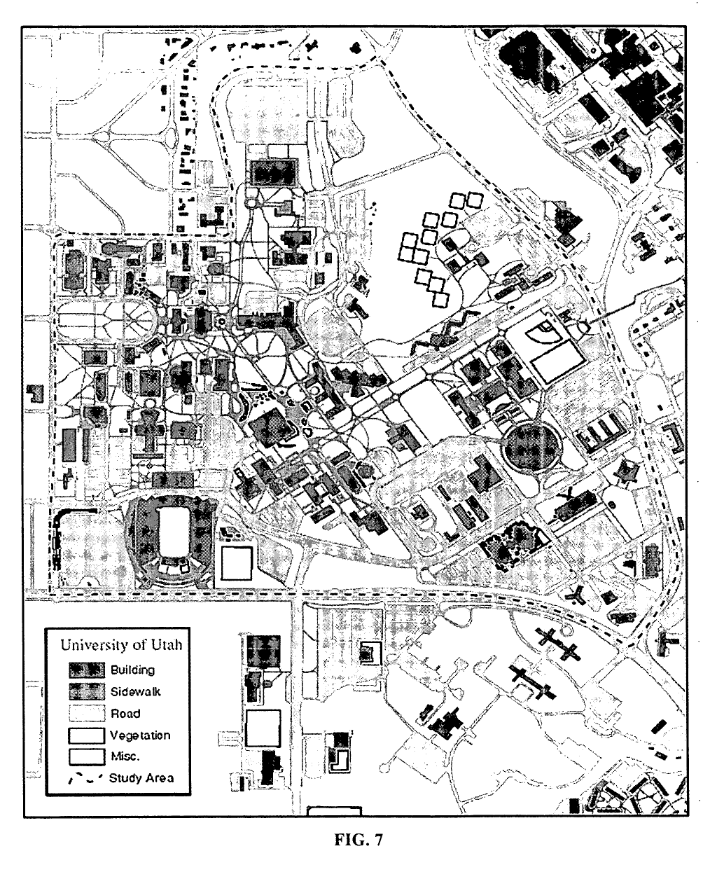

The focus of one embodiment of the present invention is to route pedestrians through an urban, suburban or campus network. For the purpose of demonstrating a proof of concept, a portion of a university campus is included this description of the present invention (FIG. 7). The dashed line in FIG. 7 defines the study area boundary. The subnetwork is defined by using the following four streets: 500 South for the southern boarder, North Campus Drive as the northern boarder, University Avenue as the western boarder and Wasatch Boulevard as the eastern most edge. This study area will be referred to as lower campus. Several attributes of the lower campus infrastructure are needed in order to implement this project, but the key objects are constructed paths of travel.

The study network for the present example includes all constructed objects utilized by pedestrians, including sidewalks, stairs, parking lots, and courtyards. Necessary objects not included within the data set complied by the CDS and the DIGIT Lab are curbs. Curbs are features in the real world that interrupt sidewalks; thus, they must be traveled and therefore included in the data set. However, curb cuts are designed to allow people of all ability levels to traverse; therefore they will be appended to the sidewalk features. Constraints, such as stairs and curbs, can be modeled using point object models, line object models, or a combination of the two. Both models can give accurate representations of obstructions and either model can be used with the shortest path algorithm discussed in the previous section. Thus, it is necessary to examine both the point and linear object model representation schemes with respect to this particular research application. Factors that are considered include computation and storage costs, maintenance, future expansion and the ease of cartographic output interpretation. After discussing the costs and benefits of using each model, the concluding choice and justification follows.

The point object model uses points, which are zero dimensional objects, to represent possible route restrictions within the pedestrian network. The point has an associated attribute that contains the affordability of the object. However, to make the point model work properly, there are two factors that must be true: each point must coincide with the existing network and it must be accurately georeferenced to reflect the relative position of the obstacle. The point object model is very effective at modeling curbs on either side of a crosswalk or at the edges of parking lots. One of the benefits of using the point representation is that it accurately represents obstructions at a geographical scale. In this instance, when the affordability of the point between two or more adjacent edges exceeds the physical ability level of the user, travel between these edges is disallowed. The point object model can also be used to model a change in attributes along an edge. For instance, if an edge contains a staircase in the middle of it, points can be added to allow passage by those who would otherwise be unable to do so. The last advantage to using the point object model is that it allows for more efficient updating functionality. This would be important in future work if the present invention were to consider temporary obstacles, such as building or road construction. It would be very efficient, useful, and more accurate in routing pedestrians if the facility management department could simply place a point on the map where construction would inhibit pedestrian traffic. Consequently, the optimal routing application could include the newly added obstacle.

When using the linear object model, all obstacles are represented using edges. Again, the list of obstacles includes objects such as stairs and curbs. In this model, the affordability of an obstacle is assigned as an attribute of an entire edge, not simply the point of obstruction. Although this may not accurately represent objects at a large map scale, such as the point at which a pedestrian is confronted with a curb, it does have several advantages. An advantage to using the linear object model is that all objects can be represented as a line. This allows the optimal path-finding algorithm to run more efficiently as a result of using a single geometric representation. Another advantage is that it eliminates all sidewalks that are not entirely passable by PWD prior to running the optimal path-finding algorithm. This leads to faster optimal path computation time. It is also important to consider a means for future expansion of this routing application to include other linear attributes such as slope or construction. The linear object model provides an easily updateable model including other possible obstacles. The linear object model does have some drawbacks. The first disadvantage is that there is no efficient way to represent nonplanar intersections of two paths of travel.

It should also be noted that storage space is a consideration; however, as primary and secondary memory devices increase in speed and decrease in cost, storage considerations will have a lesser impact on the choice of constraint representation used. It is for this reason and the others listed above that one embodiment of the present invention uses the linear object representation to model obstacles within the study network area.

In some embodiments, in order to maximize the speed of the application through the use of the linear representation, three sets of data represented in the SVG file format are stored and read by the routing application. As mentioned before, the data set in its entirety may be created and maintained in the GIS. The edges in the first set are those that are passable by ambulatory people; this includes all edges, since a staircase or curb would not hinder their travel. The second set of edges allows passage to both ambulatory and handicapped people but not to disabled people. The third set of edges includes only those edges which are passable by people of all ability levels (disabled, handicapped, and ambulatory). This design takes advantage of the user's ability level and only searches appropriate edges for the optimal route, thus minimizing computation time. With all network objects represented as linear features, each network feature is constructed spatially with an origin and destination, and each is aspatially defined by distance and affordability. The distance value is derived by calculating the distance between the origin and the destination nodes. The affordability of an object determines which physical ability level is necessary in order to traverse the constructed object. The affordability attributes are categorized into those that are traversable by all people (value 3: disabled, handicapped, and ambulatory), traversable only by handicapped and ambulatory people (value 2), or traversable only by ambulatory people (value 1). The affordability index for each object is assigned by the CDS.

The CDS office employs people to walk all paths on campus and record any possible static obstructions.

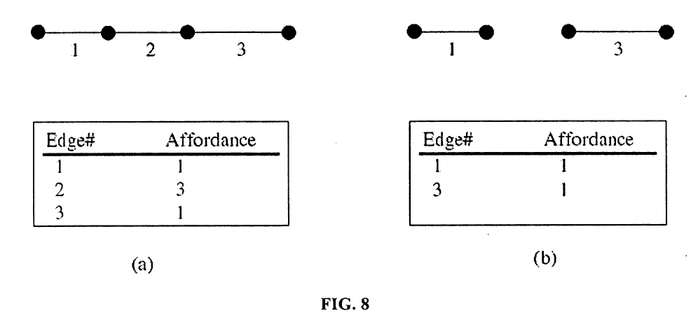

By using linear representation in modeling obstructions, in some embodiments, the possibility of problems arising due to redundancy is minimal. If points were used, on the other hand, there would be multiple data sets representing a single location in space. For example, if a point were used to represent a step in a sidewalk, the point, by definition, would coincide with the edge representation. Thus, at the location of the obstacle, there would be an edge representing the path and a point representing the obstacle. In the present invention, obstacles are represented as interruptions, or ‘gaps,’ within the network instead of being represented as points on linear features. For example, a staircase is represented as a line within the database. The line contains a point of origin and a point of destination. In some embodiment, the aspatial data includes the affordability index and the distance between the origin and destination (see FIG. 8 (a)). In some embodiments, the affordability index provides a means to discern which ability level is needed to traverse each object. For example, if a user could not afford to travel over a set of stairs, that edge would be eliminated prior to solving for the optimal route. Thus, a ‘gap’ is left in the network (see FIG. 8(b)).

In some preferred embodiments, this approach allows for greater efficiency, because only the edges that the user can traverse are evaluated in the optimal route routine. Because the percentage of edges that could be eliminated is very small, it is possible that the elimination of edges would create significant efficiency savings. A serious drawback is the updateability of this model. A point object model makes it relatively simple to incorporate temporary obstacles such as road or building construction. Nonplanar intersections, such as bridges, are handled by relaxing the planar topology. This involves not requiring a node to exist in every place where two linear features meet. Instead, the node is removed and the linear features are reconnected to form a single edge. In addition, the attributes must also be reassigned to match the newly created edge. This process of eliminating nodes improves the path-finding algorithm run time, as well as eliminates the need for additional relations to represent turns.

In some embodiments, another design decision which must be addressed is how to represent divided sidewalks. These occur several times within the network where a sidewalk is split for aesthetic purposes, such as to surround a large flower bed. There are two options for representing these. The data could be condensed into a single center line representing both sidewalks, or each sidewalk could be represented with its unique edges. Since data is available for both sidewalks in the division, no additional effort is needed to include both of them in the database. In addition, the design of the sidewalks could differ in how they compensate for slope. For example, while one side of a divided sidewalk might include steps, the parallel sidewalk might instead have a steeper slope. Thus, both sidewalks should be represented. A third reason to include both sidewalks is the scale of this study. Many of the objects represented within the database are less than three linear feet in width. At this scale, to condense the sidewalks into a single centerline would not only be inaccurate, but it could also lead to confusion if a pedestrian were searching for the divided sidewalk as a landmark. Although including the additional edges would increase the computational run-time of the optimal path, for the reasons stated above, preferred embodiments of the present invention would include both sidewalks in the database.

One embodiment of the present invention loosely couples several software components. The data collection and construction may be handled in some embodiments by using several Geographic Information System (GIS) software. Once the data are complete, they are transformed in some embodiments into Scalar Vector Graphics (SVG) in order to enhance the visual presentation by maximizing on-screen display precision. Lastly, the data may be transformed into a format readable by Java 2. This last transformation may be made in order to utilize the speed and efficiency of Java, which is easily incorporated into Web applications. However, other software applications may be applied.

In one embodiment of the present invention using a university campus as an example, the base campus data are collected by trained personnel in the facility management department. In some embodiments, the data may be constructed by engineers using Computer Aided Design software (CAD), The data may be georeferenced into Universal Transverse Mercator (UTM), zone 12, with units in meters. One of the benefits of re-projecting the data is that it allows for the integration of other data sources, such as Digital Orthographic Quadrangles (DOQs) and GPS data.

Positional data related to obstructions can be collected in a variety of ways. In one embodiment of the present invention, GPS data is used to collect data related to obstructions. In one embodiment of the present invention the GPS is used as a means to collect data on all curbs that might interrupt travel for PWD. In one embodiment of the present invention, positions are taken, for each point, for an average of 30 seconds to 54 ensure accuracies. The data created utilizing a GPS may then be imported into a data network. For example, the data created may be imported into the ArcINFO GIS® coverage format where they are integrated with the base campus data.

In another embodiment of the present invention, data related to obstructions was collected by coordination with information bureaus and other experts. As one example of this embodiment of data collection, data related to obstructions was collected in collaboration with local experts on a university campus. In this example, a paper base map of the study area was given to the local experts. The local experts then sent individuals out with maps to collect data. The individuals were assigned the task of walking all possible paths of travel in an area and to mark all possible obstructions on the map in red. In this example, the marked map was then taken back to a computer laboratory where noted obstructions were entered into the data network. For example, the data could be entered into the ArcGIS coverage.

In some embodiments of the present invention the three data sets, (CAD data, GPS data, and the data provided by local experts), are compiled into a single format. In preferred embodiments ArcINFO® coverage format is the chosen format because of its data construction accuracies, topological structure, and the ease of attributing the data. As stated before, the CAD data may be imported into ArcINFO® and then georeferenced. The GPS data may be then imported and integrated with the base campus map. The data from local experts may be digitized into the campus coverage. With all the necessary data inputted, paper maps may be made for quality control purposes. In preferred embodiments, once the data passes quality control, ArcINFO's® build command is run in order to build line topology. This process ensures that there will be a node at every edge intersection. This may appear to be an extra step, however, it eliminates object redundancies and ensures connectivity. All maintenance and updating procedures are handled in the ArcINFO's® ArcEdit® environment in order to maintain connectivity between edges.

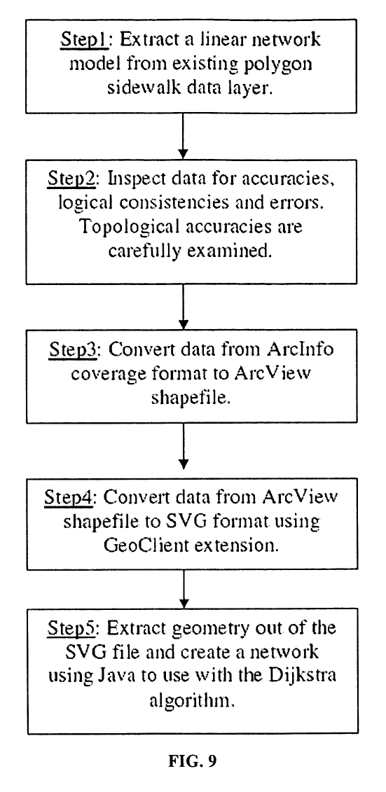

In some embodiments of the present invention steps are taken to transform the data into the appropriate data formats for display, querying, and running the optimal path algorithm. An example of this process is illustrated in FIG. 9. In a preferred embodiment, the first step in the data transformation process extracts a pedestrian network from the existing ArcINFO® polygon coverage of lower campus. Prior to this step, the sidewalk is a polygon with attributes. The conversion to edges and vertices occurs using the centerline command in Arc. The centerline command produces centerlines (singlelines) from dual-line features, such as sidewalk casings, based on user-specified width tolerances. This can also be accomplished in ArcEdit®; however, in ArcEdit®, the polygons are processed one at a time. This would eliminate one step in the quality control process. However, the cost of interactively creating centerlines is time consuming and cumbersome.

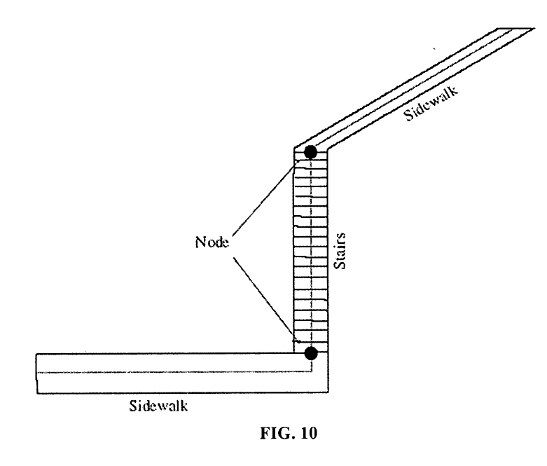

Although the centerline command appears to be a good solution, it has some drawbacks. The disadvantage is that a minimum width and a maximum width must be specified. However, in areas such as courtyards and points where several sidewalks intersect, the result may be less than desirable. These ‘problem areas’ may need to be cleaned up after the centerline command has been run. Also, the user must experiment with parameter settings in order to obtain the desired results. The end result is a polyline coverage representing the pedestrian route. Each edge in the network obtains the attribute from its parent polygon. FIG. 10 shows how nodes are placed in the appropriate locations to signify the beginning and ending of a staircase.

For a preferred embodiment of the present invention, the second step in the data transformation process inspects the pedestrian network for accuracies, logical consistencies and any errors. Items such as edge distance, edge affordability index, and topological accuracies must be carefully examined for errors. Edges were randomly cross checked with their respective parent polygon in order ensure that the centerline transformation produces the best possible representation.

For a preferred embodiment of the present invention, step three of the data transformation process involves transforming the data from the ArcINFO® format to ArcView® shapefile format. The reason that the ShapeFile format is not used for data construction is two-fold. First, since ArcView® does not support topological relationships, it would be insufficient for creating a connective network. It is, however, able to maintain positional accuracies of nodes and edges. The second reason for using ArcView® is related to the display of the data in the end-product. The end product is a Scalar Vector Graphics (SVG) document. Even though there is not an export function in ArcINFO® to convert coverage to an SVG document, there is a third party ArcView® extension which allows shapefiles to be exported from ArcView 3.x to a SVG document. Prior to converting the data into the SVG format, all desired cartographic changes must be made. This includes changing any colors, defining the extent of the map and prioritizing data layer ordering.

Step four, in this preferred embodiment, of the data transformation process begins with an ArcView 3.x view document and converts it into a SVG document using a third party extension called GeoClient®. GeoClient® is built on ArcView Avenue® scripting language, thus making the program work both quickly and efficiently. The GeoClient® extension takes all active themes within the current view and Node placements to delineate stairs converts them into a single SVG document. Because SVG is built on the Extensible Markup Language, it allows GeoClient to preserve both attribute data and spatial data within a single file. One of the advantages to using SVG is that it supports both textual and geographical queries.

The fifth and final step, of this preferred embodiment, in the data transformation process uses the geometric information within the SVG file to create a database that allows for efficient search and retrieval information in order to find an optimal path. To do this, a Java program parses the SVG file and creates three Java objects: a list of unique nodes (nodeList.map), a list of unique edges (edge.map), and a neighbor object (neighbor.map). Nodes and edges are the standard building blocks for implementing the shortest path algorithm. Nodes are zero dimensional objects defined by two numbers. The first number represents the x-coordinate and the second represents the y-coordinate. Edges are constructed using a start node, an end node, and a distance value representing the length of the edge. The neighbors are additional sources of information that are constructed in order to decrease the optimal path computation time. A neighbor object is composed of a node object and an integer value representing the distance (the distance of the edge which connected the neighboring node). The neighbors are stored in a hashmap where the key value is a unique node, and the value is the list of neighbors for that node. The purpose of using the hashmap data structure is to capitalize on the most efficient random access function within the Java environment. When the path-finding algorithm needs to identify neighbors, it simply uses the node to reference all of them. Although the hashmap data structure appears to behave much like the forward star structure (FSS), the number of steps needed to calculate connected nodes is reduced from three steps to a single step. The result of this last data conversion step is that three Java objects are created, namely, a hashmap of edges, a hashmap of nodes, and a hashmap of neighbors. Once created, they are ready to be queried by the shortest path algorithm.

In some embodiments, the shortest feasible path algorithm is designed to solve for the optimal path from a user defined origin to their destination, with respect to their defined physical ability level. There are five major steps to this algorithm: (1) identifying the affordable edges, (2) defining the path-finding variables, (3) initializing the path-finding algorithm, (4) identifying the edges that comprise the optimal path, and (5) displaying the solution. Each aspect is discussed in detail below.

In some embodiments, the first step towards solving for the optimal path is identifying which edges the user can physically traverse. For one embodiment of the present invention there are three sets of edges stored. They include the entire pedestrian network, the network minus stairs, and the pedestrian network minus stairs and curbs. In the creation process of these three data sets, careful attention must be paid to the edge identification numbering schema. The edge feature numbering system must be consistent with the SVG document. The reason is that when the application has identified the edges traversable by the user, these edges are highlighted using their feature identification number. Thus, when the subnetworks are created, the application must be sure to match the identification number with the corresponding edge in the master network data set. Using this design, the path-finding algorithm identifies the data set and runs the algorithm based upon the selected physical ability level.

In preferred embodiments, the variables needed for the shortest path-finding algorithm are passed to the Java program using a text string. The first variable defines the ability level of the user. This value determines which data set will be used during the path-finding routine. The second variable is the x-coordinate for the origin, and the third is its y-coordinate. Similarly, the fourth variable is the x-coordinate for the user's destination and the fifth is its y-coordinate.

The first step within the path-finding routine of preferred embodiments requires the creation and initialization of four data sets. The four data sets are: i) the best estimate of the shortest distance, ii) the predecessor of each vertex, iii) the set of settled vertices, and iv) the set of unsettled vertices. Since all network identification numbers for edges and nodes are stored values, they do not need to be initialized. For each node, the distance is initialized to infinity (or in Java, the maximum integer). This may be done because if the algorithm finds a distance shorter than the current value, the current value is replaced with the newly acquired distance. In some embodiments, this ensures that the shortest distance to each node is found. If there are any nodes with a value of infinity when the algorithm has finished, it either means that the node is not reachable, or that the destination was found prior to reaching the node. The hashmap of the predecessors is emptied using the Java function clear( ). This may be done to ensure that there are no elements in the predecessor data set prior to beginning the algorithm. Note that the origin node will not have a parent node. The set of settled vertices and the set of unsettled vertices are also emptied in this initialization step. There should not be any settled nodes until the origin is identified and added. The set of unsettled vertices should also remain empty until the function relaxneighbors( ) is called for the origin vertex.

The second step of the path-finding in preferred embodiments is designed to identify the origin and the destination nodes. This is a two-step process in some preferred embodiments. The first step is to acquire the coordinates chosen by the user. This is done by passing an array to the program. The program then creates two new node objects with the coordinates. In the next step, the closest node within the network to the desired node is found and its distance is calculated. Once the origin node (u) is identified, the algorithm sets the distance from u to 0 and adds u to the unsettledNodes set.

The last initialization step for the optimal path routine in some preferred embodiments is to determine which edges could be feasibly traversed by the user. This is done by passing the algorithm an array, where the first number in the array determines which set of edges are acceptable. If the user can traverse all the edges within the University of Utah network, the value of that first number is one. If they cannot traverse large obstacles such as stairs, but can manage smaller obstacles such as curbs, the value is two. Lastly, if the person is disabled and cannot traverse obstacles greater than two inches in height, the value is three.

In some embodiments, the implementation of an algorithm for finding the optimal route through a network for Internet users uses the Dijkstra algorithm for routing pedestrians through a network of sidewalks. The path-finding algorithm could be implemented in several different environments; however, in preferred embodiments the Java 2 environment was chosen. The disadvantage to using Java 2 is that it is difficult to create a graphic representation of the solution route. There is no easy way to display the results in a meaningful manner. To alleviate this downfall, JavaScript may be used to communicate between the graphical user interface and the path-finding algorithm.

As discussed above, there are four data structures needed for the algorithm of some embodiments. The shortest distance from the source to each vertex, the predecessor of each vertex the set of settled vertices, and lastly, the set of unsettled vertices. The algorithm uses these four data structures and then undergoes these subsequent three functions in order to compute the shortest path. First, the minimum element (u) is extracted from the set of unsettled vertices (Q). Next, u is added to the set of settled vertices (S). Finally, the neighbors of u are relaxed. These three functions are encapsulated within a while loop allowing the loop to run until all vertices have been reached or the destination node is found (therefore terminating the algorithm). The three functions are described in detail below.

The first step in the path-finding routine in some embodiments entails extracting the minimum element, u, from Q is a set of neighbor objects that are sorted depending upon their distance value. Therefore, this first step simply obtains the first element within Q and assigns it to the temporary neighbor variable u. The obtained value is then deleted from Q so that it will not be considered again. It should be noted that the first time this loop is run, the minimum neighbor object that is removed from Q is the origin node with a distance value of zero.

The second step in the algorithm of some embodiments takes u and adds it to S. In doing so, the algorithm is sure to have found the shortest path to that vertex. This is consistent with the origin node in that the distance value assigned to the origin vertex is zero. The relaxing-neighbors function begins by gathering a list of all the vertices connected to the current node (u). This is done by calling the hashmap with the affordable edges using the u as the key value. The hashmap returns a list of all the vertices that are connected as neighbor objects, meaning that they have a distance value associated with them. For each neighbor object that is adjacent to u, the algorithm first checks to see if it is connected in S. If so, then the shortest distance to that node has already been found and is therefore not considered in the rest of the algorithm. If the object is not found in S, then a check is done for the best estimate of the shortest distance to that element (note these were all set to infinity prior to beginning the algorithm). If the distance assigned to the connected vertex (v) is greater than the sum of the distance from the origin to u plus the distance from u to v(d(v)>d(u)+[u,v]), then the best estimate is updated to reflect the new distance and the neighbor is inserted in order into the set of unsettled vertices.

The last step in the path-finding routine in some embodiments entails identifying the edges that connect the list of nodes that compose the shortest path. In order to display the path graphically, the edges that connect the nodes must be identified. Therefore, a subroutine searches through the hashmap of predecessors and identifies the current node and its predecessor. After identifying the two nodes that compose the edge, a list of edges is searched in order to identify the integer value that represents the edge. Once the edge value is found, it is added to a list. Once the subroutine is finished, meaning that the origin value was found, the list of affordable edges that compose the shortest path is returned to the user.

The presentation of the present invention plays a role in the success of the application. An attractive, functional, intuitively designed interface increases the likelihood of being used by the intended user community. On the other hand, if the interface is poorly designed where navigation and information retrieval is difficult, users will be less likely to use it.

Two major elements may be considered when utilizing the Web as the interface for presenting the present invention. The first element is the spatial data (or the map). The second consideration is the available tools that assist users in navigation and information retrieval within the Website. In some embodiments, the spatial data utilizes SVG technology. SVG has the advantage of displaying vector graphics and it has the ability to attach attribute data to the features. The navigation tools are built with JavaScript® technology. The combination of SVG and JavaScript® provides a robust, scaleable, and efficient Web application that provides a full suite of tools for data querying and routing.

The primary purpose of the map is to model features in the real world. There are several ways of representing a pedestrian environment on a map. Three issues to consider regarding the presentation of the present invention include the general design constraints due to the Web interface, content, and the results. Although the Web provides greater accessibility to users, there are two major factors that limit the cartographic abilities of Web based maps, namely, screen size and screen resolution. These limitations are independent of the subject matter. The size of the map is limited to the size of the user's screen. If the map is larger than the screen, users must pan to see certain parts of the map. This makes the application less attractive and less interactive since it takes more time to see the entire map. Typically, Web-designers design pages for the lowest common denominator (i.e. the smallest screen). The present invention avoids the dilemma of screen size by evaluating the size of the user's browser window and scales the map appropriately based on the available area. This allows access to the entire map, regardless of the size of the user's monitor.

The second limitation of Internet mapping is the screen resolution. Standard desktop printers have a minimum resolution of 300 dots per inch (dpi) and monitors generally have resolutions between 60 dpi and 100 dpi. This coarse resolution pixilates cartographic elements such as smaller text and symbols. Again, some embodiments of the present invention avoid this dilemma by using SVG technology. In vector technology, no matter how much the user zooms in, no pixilation will occur.

A second consideration for presenting spatial data within the present invention is the choice of content. This is a complex choice in Internet mapping because there is no predefined list of elements. For some embodiments of the present invention, the necessary elements include sidewalks, campus buildings, curb cuts, stairs, handicapped parking stalls and accessible building entries.

A third for the presentation of spatial data via the Web is how to display the optimal route solution. The optimal result is a subset of the pedestrian network. Therefore, it may be symbolized in a manner that would make it stand out from the base network. A preferred embodiment in the present invention is where the optimal solution is represented as a line in a color that differentiates it from the background of the map to make the results stand out.

The artographic elements and the navigation tools, while discussed separately, are linked. The cartographic display would be less useful without tools; likewise, tools would have little utility without a map. In some embodiments there are three main types of tools that may be offered when an Internet service is combined with a map. These are tools that enable map navigation or browsing, tools that control the map's appearance, and tools that perform spatial queries.

The present invention contemplates the use of a larger variety of tools. Map navigation, also known as browsing, is allowing the users to move their window, which displays a portion of the area to an area of interest. This functionality involves several tools such as zooming, panning, and moving in a certain direction (i.e., north, south, east, and west). In preferred embodiments, the three tools provided to grant this functionality are the zoom-in button, the zoom-out button, and the zoom-full-extent button.

These tools become very effective when combined with a locator window. The locator map is a smaller scale map of the entire study area located in the upper right hand corner of the browser window. Within the locator map, there is a shaded box that indicates the current portion of pedestrian environment displayed on the screen. The extent box can be moved to a different location by clicking and dragging the box over the desired spatial extent. In preferred embodiments, the combination of these navigational tools provides an intuitive interface that is easy to learn and effective to use.

In addition to the navigational tools discussed above, preferred embodiments of the present invention provide the user with tools to solve network routing problems. The routing tool in some preferred embodiments allow users to input an origin, a destination, and a physical ability level that most closely describes them.

Another preferred embodiment in the routing tool is the Map-It button. When the user hits this button, it sends the parameters that were selected by the user to the optimal routing program located on the server. The server accepts the input parameters and derives a list of edges that compose the optimal route. This list of features is passed back to the interface where JavaScript highlights the optimal path. The routing tool and the back-end path-finding application provide users with increased information about the environment relative to the ability level of the user.

### 3. EXAMPLES

This section provides an example of both the user interface and the routing routine. The utilized embodiment uses Scalar Vector Graphics (SVG) for displaying a campus map via the Web. JavaScript was used to develop an interactive user interface, not only for general online mapping tools, but also for the routing tool. Lastly, Java technology was used to provide a robust path-finding application. Although this application demonstration uses a small network due the restrictions of data collection, it is possible to input the data for the larger geographic domains into the present invention for general public use. This section begins with a description of the tools provided to users and their functions. After each component is reviewed, test cases are given. The test cases are not used to highlight the differences in the resulting distances between nondisabled people and PWDs, but rather to illustrate the complexity of routing PWDs.

### Example One

A preferred embodiment of the present invention is designed to provide a clear, straightforward Internet application for inexperienced Internet users. Because computer literacy is not adequate among all individuals, all choices are made by using mouse clicks on either the ‘buttons’ or on the map. Key commands are kept to a minimum to ensure clarity and visibility, as well as to guard against mistakes.

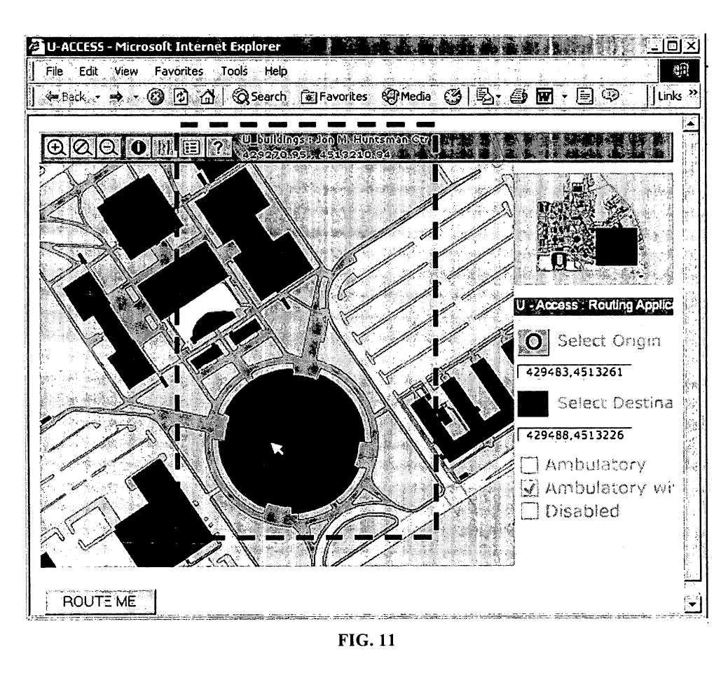

The preferred embodiment begins with a user loading the Web page. The page consists of four components. The main component is the map which provides the user with a spatial reference, as well as attributes about the data. The attribute data is obtained by ‘hovering’ the mouse over a building. The name of the building is automatically displayed in the center of the toolbar. Within the dashed line in FIG. 11, the mouse is over the Jon M. Huntsman Center and the name is displayed in the toolbar.

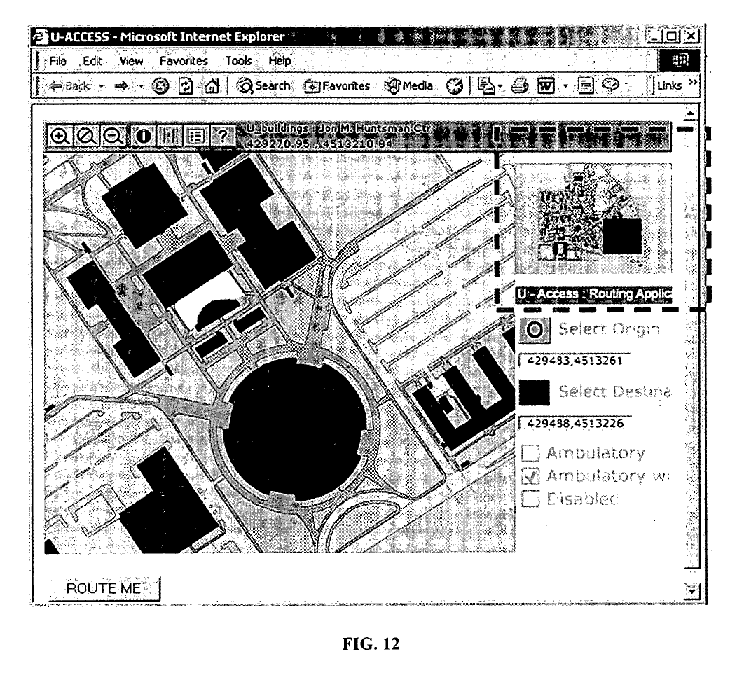

The second component of the preferred embodiment is the locator map. The locator map is a smaller scale map of the entire study area located in the upper right hand corner of the browser window. Because this map is linked to the scale and location of the main map, when the user zooms in on the main map, a box in the locator map highlights the viewable area. This allows the user to easily identify where he/she is relative to the entire study region (see FIG. 12).

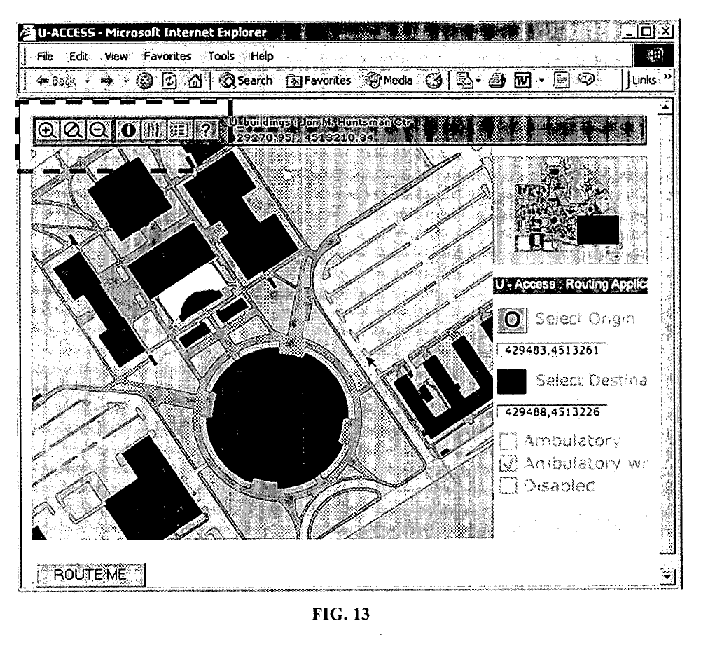

The third component of the preferred embodiment is the tool bar. The tool bar is a series of buttons located at the top of the map which prove tools to help navigate through the map. It contains tools such as a ‘zoom-in’ function, ‘zoom-out,’ a search tool that enables the user to search for a building by name, and an identify tool that allows the user to ‘identify’ features on the map (see FIG. 13).

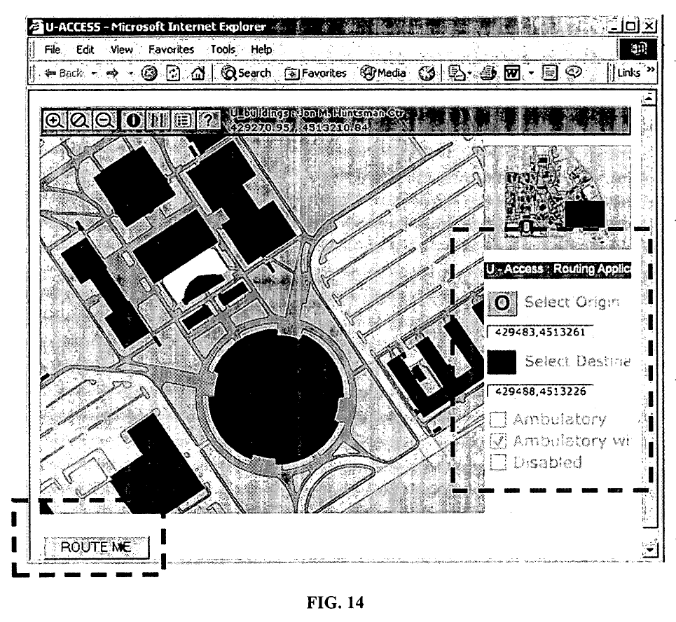

The last component of the preferred embodiment is the routing tool box. The routing tool box is a frame located under the locater map which allows the users to select an origin, a destination, and an appropriate mobility level. Within the tool box, there are three buttons as well as the option to choose an ability level. The first button activates a tool which allows a user to define their origin. The second button allows the user to define their destination by clicking on the appropriate location on the map. The coordinates of the origin and destination identified by the user are recorded in the text box under the tool. The last option the user has is to choose an appropriate ability level. This option is selected with radial buttons to ensure that the user only selects one ability level. In this manner, the user is able to personalize their route parameters (see FIG. 14). If the user has failed to enter in any of the necessary parameters, a pop-up window appears telling the user to finish supplying the necessary information. The final element of this preferred embodiment of the routing tool is the “ROUTE ME” button located in the lower right corner of the explore window. Once a user has entered in the necessary data, the user may then select the “ROUTE ME” button to invoke the application to find and highlight the route.

In some embodiments, once the path-finding routine has been invoked by the user, the shortest path algorithm solves for the optimal route. A single Java program is run using the user defined parameters. Note that in preferred embodiments the network is not rebuilt for each run time, since a separate network is maintained for each ability level in order to minimize computation time. The path-finding algorithm uses the physical ability level input to determine which data set to use. If no path is possible within the framework of the given parameters, the application returns an error message stating that the desired route is not possible. Because the path-finding routine is not seen by the user, the process is not shown here. Once the Java program has computed the optimal path, the result is displayed for the user. The route-finding algorithm returns a list of edge features that compose the optimal route. JavaScript parses the string of feature numbers and highlights each edge feature that is a part of the accessible route. The total distance is displayed in the bottom text box within the routing tool window. If no route is found, the distance is set to zero and the user is notified that a path does not exist between the two points they defined.

### Example Two

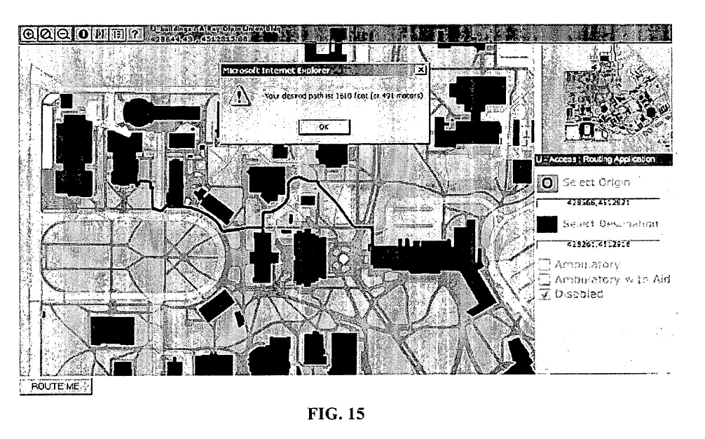

In a test case, a disabled user and an ambulatory user are routed from the Union building to Kingsbury Hall to illustrate the different routes which preferred embodiments of the present invention generates. In this case, the disabled user first activates the tool to select the origin. With the tool active, they move the mouse over the Union building and click on the left mouse button in order to specify their origin. Next, the user selects the destination tool, moves the mouse over Kingsbury Hall, and left clicks again. With these two points plotted, the user must next choose which ability level best describes them. In this case, the user selects the “Disabled” button. The last step for the user is to hit the “Route Me” button. This invokes the present invention to solve for the shortest path between the selected origin and destination. Once the present invention has solved for the route, the route is highlighted for the user and a message box appears with the length of the path, given in both feet and meters (see FIG. 15).

### Example Three

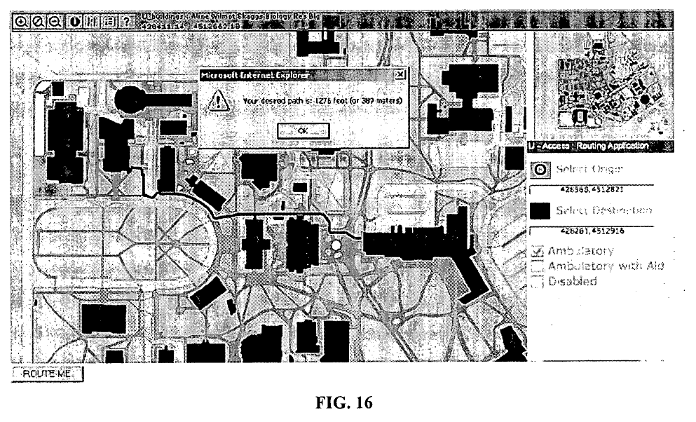

Another route scenario in this test case uses the same origin and destinations as the previous test case one; however, the ability level is changed from disabled to ambulatory. The result of the second user is shown in FIG. 16. The route for the disabled person is 334 feet or 102 meters longer than the ambulatory person. This difference is due to the staircase located just north of both the Park building and the Student Services building. These test cases are not intended to highlight the disadvantage of disabled people, rather they are provided to reveal the circuitous route that a disabled person must take in order to arrive at the same destination as an ambulatory person.

### Example Four

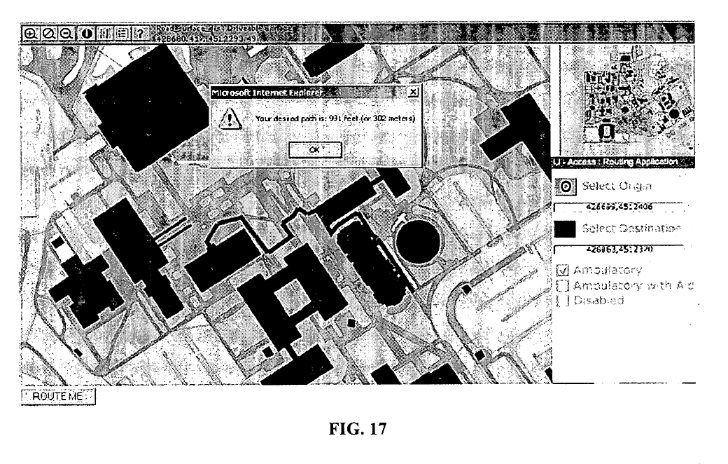

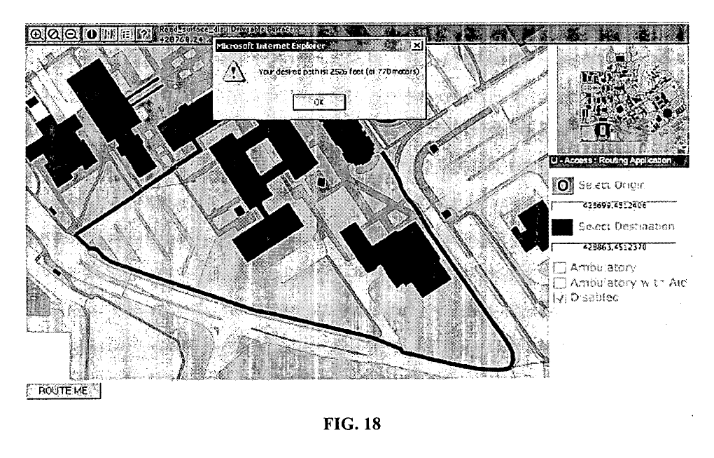

Another test case compares the route differences between a second set of buildings: the Fine Arts building and C. Roland Christian Center (see FIGS. 17 and 18). The primary differences in the routes are due to the stairs located in front of the Fine Arts building. While an ambulatory and ambulatory with aid person can leave via any exit, a disabled person must exit the building via the south exit. This forces the disabled person to first travel west, down the hill, and then around the obstacle. Again, while the route distances vary, these test cases merely serve to inform the users.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method of using a computer program system to identify routes through: pedestrian environments comprising:
accumulating data related to pedestrian environment;
receiving input from a user, wherein said input comprises the ability level of the user;
processing accumulated data and user input;
identifying route for travel; and
displaying route for travel.

2. The method of claim 1, wherein the data related to the pedestrian environment comprises data obtained via the Global Positioning System.

3. The method of claim 1, wherein the data related to the pedestrian environment comprises data obtained via remotely sensed data.

4. The method of claim 1, wherein the data related to the pedestrian environment is accumulated and assembled within a GIS.

5. The method of claim 4, wherein the GIS data set is transformed into an SVG dataset.

6. The method of claim 1, wherein the data related to the pedestrian environment comprises data selected from a list consisting of structural obstructions, spatial and path mapping of building interiors, temporary obstructions, steps, curbs, slope, surface roughness, narrow pavements, uneven paving slabs, raised manholes, street furniture, handrails and congested pavements, start and ending points for stairs, curb cuts, accessible building entrances, and handicapped ramps.

7. The method of claim 1 wherein the process of identifying the route to travel comprises a consideration of an element selected from a list consisting of structural obstructions, spatial and path mapping of building interiors, temporary obstructions, steps, curbs, slope, surface roughness, narrow pavements, uneven paving slabs, raised manholes, street furniture, handrails and congested pavements, start and ending points for stairs, curb cuts, accessible building entrances, and handicapped ramps.

8. The method of claim 1, wherein the process of identifying the route to travel comprises the step of eliminating all network edges that are not affordable to the user.

9. The method of claim 1, wherein alternative data-basing structures are used depending on the relative importance of data redundancy and run-time efficiency in a given situation.

10. The method of claim 1, wherein the computer program is a Web-based navigational tool.

11. The method of claim 1, wherein the computer program allows users to select an origin, a destination, and an ability level.

12. The method of claim 1, wherein the computer program allows the user to choose which of three options best matches their ability level: ambulatory, ambulatory with aid, or disabled.

13. The method of claim 1, wherein the computer program determines the shortest path considering the physical limitations of the user.

14. A computer program product for implementing within a computer system a method for providing navigational information, the computer program product comprising:
a computer readable medium for providing computer program code means utilized to implement the method, wherein the computer program code means is comprised of executable code for implementing the steps for:
accumulating data related to pedestrian environment;
receiving input from a user, wherein said input comprises the ability level of the user;
processing accumulated data and user input;
identifying route for travel; and
displaying route for travel.

15. The computer program of claim 14, wherein the data related to the pedestrian environment comprises data obtained via the Global Positioning System.

16. The computer program of claim 14, wherein the data related to the pedestrian environment comprises data obtained via remotely sensed data.

17. The computer program of claim 14, wherein the data related to the pedestrian environment is accumulated and assembled within a GIS.

18. The computer program of claim 17, wherein the GIS data set is transformed into an SVG dataset.

19. The computer program of claim 14, wherein the data related to the pedestrian environment comprises data selected from a list consisting of structural obstructions, spatial and path mapping of building interiors, temporary obstructions, steps, curbs, slope, surface roughness, narrow pavements, uneven paving slabs, raised manholes, street furniture, handrails and congested pavements, start and ending points for stairs, curb cuts, accessible building entrances, and handicapped ramps.

20. The computer program of claim 14, wherein the process of identifying the route to travel comprises the step of eliminating all network edges that are not affordable to the user.

21. The computer program of claim 14, wherein alternative data-basing structures are used depending on the relative importance of data redundancy and run-time efficiency in a given situation.

22. The computer program of claim 14, wherein the computer program is a Web-based navigational tool.

23. The computer program of claim 14, wherein the computer program allows users to select an origin, a destination, and an ability level.

24. The method of claim 14, wherein the computer program allows the user to choose which of three options best matches their ability level: ambulatory, ambulatory with aid, or disabled.

25. The method of claim 14, wherein the computer program determines the shortest path considering the physical limitations of the user.
